(19) United States
(12) Patent Application Publication
(10) Pub. No.: US 2005/0039056 A1
(43) Pub. Date: Feb. 17, 2005

(54) Method and apparatus for authenticating a user using three party question protocol

(76) Inventors: Amit Bagga, Green Brook, NJ (US); Jon Bentley, New Providence, NJ (US); Lawrence O'Gorman, Madison, NJ (US)

Correspondence Address: Ryan, Mason & Lewis, LLP, Suite 205, 1300 Post Road, Fairfield, CT, 06824, US

(21) Appl. No.: 10/626,482

(22) Filed: Jul. 24, 2003

(51) Int. Cl. H04K 1/00; H04L 9/00

(52) U.S. Cl. 713/202

(57) ABSTRACT

A three party authenticating protocol is disclosed. During an enrollment phase, a user contacts a call center and is directed to a user verification server. The user verification server instructs the user to select and answer a number of questions that will be used for verification. The selected questions along with identifying indices for each question are stored at the user's location and at the user verification server. The user verification server sends the question indices to the call center, which in turn sends these indices to the user to obtain answer indices for each question. During a verification phase, the user contacts the call center and an authentication module asks the user to provide an asserted identity. The authentication module provides a random selection of question indices from those selected by the user. The user provides answer indices for each question to the authentication module. If the number of correctly matching answers exceeds a threshold, then the user is verified. Otherwise, the user fails verification. After verification, the user is transferred from the authentication module of the call center to a human agent for further processing.

### CROSS-REFERENCE TO RELATED APPLICATIONS

The present application is related to U.S. patent application Ser. No. ______ entitled “Method and Apparatus for Authenticating a User Using Query Directed Passwords” (Attorney Docket Number 502078), incorporated by reference herein.

### FIELD OF THE INVENTION

The present invention relates generally to user authentication techniques and more particularly, to methods and apparatus for authenticating a user using a question-response procedure.

### BACKGROUND OF THE INVENTION

A number of security issues arise when computers or other resources are accessible by humans. Most computers and computer networks incorporate computer security techniques, such as access control mechanisms, to prevent unauthorized users from accessing remote resources. Human authentication is the process of verifying the identity of a user in a computer system, often as a prerequisite to allowing access to resources in the system. A number of authentication protocols have been proposed or suggested to prevent the unauthorized access of remote resources. In one variation, each user has a password that is presumably known only to the authorized user and to the authenticating host. Before accessing the remote resource, the user must provide the appropriate password, to prove his or her authority.

A simple password mechanism, however, often does not provide sufficient security for a given application, since many users select a password that is easy to remember and therefore easy for an attacker to guess. In order to improve the security of passwords, the number of login attempts is often limited (to prevent an attacker from guessing a password) and users are often required to change their password periodically. Some systems use simple methods such as minimum password length and prohibition of dictionary words to evaluate a user selected password at the time the password is selected, to ensure that the password is not particularly susceptible to being guessed. In addition, many systems encrypt a password before it is transmitted from a user's terminal, to ensure that the password cannot be read when it is transmitted.

One-time, challenge-response passwords have been proposed as a mechanism for further increasing security. Generally, users are assigned a secret key, presumably known only to the user and the remote resource. The secret key may be stored, for example, on a pocket token or a computer-readable card. Upon attempting to access a desired remote resource, a random value, known as a “challenge,” is issued to the user. The user then generates an appropriate “response” to the challenge by encrypting the received challenge with the user's secret key (read from the pocket token or computer-readable card), using a known encryption algorithm, such as the data encryption standard (DES). The user transmits the calculated response to the desired remote resource, and obtains access to the requested resource if the response is accurate. In order to ensure that the pocket token or computer-readable card is being utilized by the associated authorized user, the security may be supplemented by requiring the user to enter a memorized PIN (personal identification number) or password.

In a call center environment, users are often authenticated using traditional query-directed authentication techniques by asking them personal questions, such as their social security number, date of birth or mother's maiden name. The query can be thought of as a hint to “pull” a fact from a user's long term memory. As such, the answer need not be memorized. Although convenient, traditional authentication protocols based on queries are not particularly secure. For example, most authentication systems employing this approach use a limited number of questions that are static and factual. Thus, the answers can generally be anticipated and easily learned by a potential attacker. Furthermore, the information is generally relayed by the user “in the open;” i.e., an attacker overhearing the call or looking over the shoulder of a user entering the information into a web browser can learn the personal information and thereafter obtain unauthorized access. A need therefore exists for an authentication technique that provides the convenience and familiarity of traditional query directed authentication with greater security.

### SUMMARY OF THE INVENTION

Generally, a method and apparatus are disclosed for authenticating a user using a three party question protocol. The disclosed three party protocol verifies the identity of a user while maintaining the privacy of user information and providing increased security. During an enrollment phase, a user contacts a call center and if the user has not previously enrolled, the user is directed to a user verification server. The user verification server instructs the user to select a number of questions that the user will subsequently use for verification. The user selects questions and the questions including indices (identifiers) of the questions are stored at the user's location, for example, in a computer file or printed on paper. The user verification server also stores the questions that the user has chosen with corresponding question indices. The user verification server sends the question indices to the call center. The call center then sends these indices to the user and instructs the user to return corresponding answers or answer indices for each of the question indices back to the call center. At this stage, the user verification server has a record of the user along with question indices and textual questions that the user has selected. The call center has a list of question indices along with answers or answer indices to each question that the user has selected. The user has the question indices and textual questions that he or she has selected. The user also has knowledge of the answers for each question.

During a verification phase, the user contacts the call center and is first connected to an authentication module that is part of the call center. The authentication module asks the user to provide an asserted identity. The authentication module chooses a random selection of questions for that user. The authentication module provides the selected questions (or indices identifying the questions, for example, in a previously provided codebook) to the user. The user answers each question and returns to the authentication module either the textual answer or an index of that answer. The authentication module compares received answers or answer indices for each question index against stored answers and if the number of correctly matching answers exceeds a threshold, then the user is verified. Otherwise, the user fails verification. After verification, the user is transferred from the authentication module of the call center to a human agent for further processing.

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIGS. 2A and 2B illustrate the flow of information in the network of FIG. 1 in accordance with enrollment and verification phases of the present invention, respectively;

FIG. 3 is a schematic block diagram illustrating the user verification server of FIGS. 1 and 2 in further detail;

FIG. 4 is a sample table from an exemplary question database of FIGS. 1 and 2;

FIG. 5 is a sample table from an exemplary user database of FIGS. 1 and 2; and

FIG. 6 is a flow chart describing an exemplary implementation of a user identity verification process incorporating features of the present invention.

### DETAILED DESCRIPTION

The present invention recognizes that authentication schemes based on queries are convenient and familiar. According to one aspect of the present invention, an authentication scheme is provided that extends query directed authentication to provide a three party protocol for verifying the identity of a user that maintains the privacy of user information and provides increased security.

FIG. 1 illustrates the network environment in which the present invention can operate. As shown in FIG. 1, a user employing a user device 110 attempts to contact a call center or web server 130 (hereinafter, collectively referred to as call center 130) over a network 120. The network(s) 120 may be any combination of wired or wireless networks, such as the Internet and the Public Switched Telephone Network (PSTN). The present invention provides a user verification server 300, discussed further below in conjunction with FIG. 3, to identify a user 110 on behalf of the call center 130 to protect the privacy of the user's records and the integrity of the information of the call center 130.

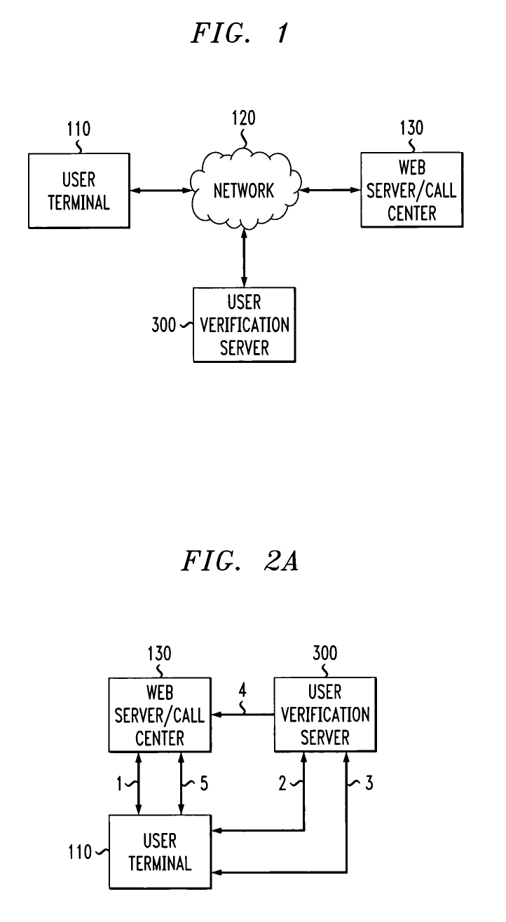

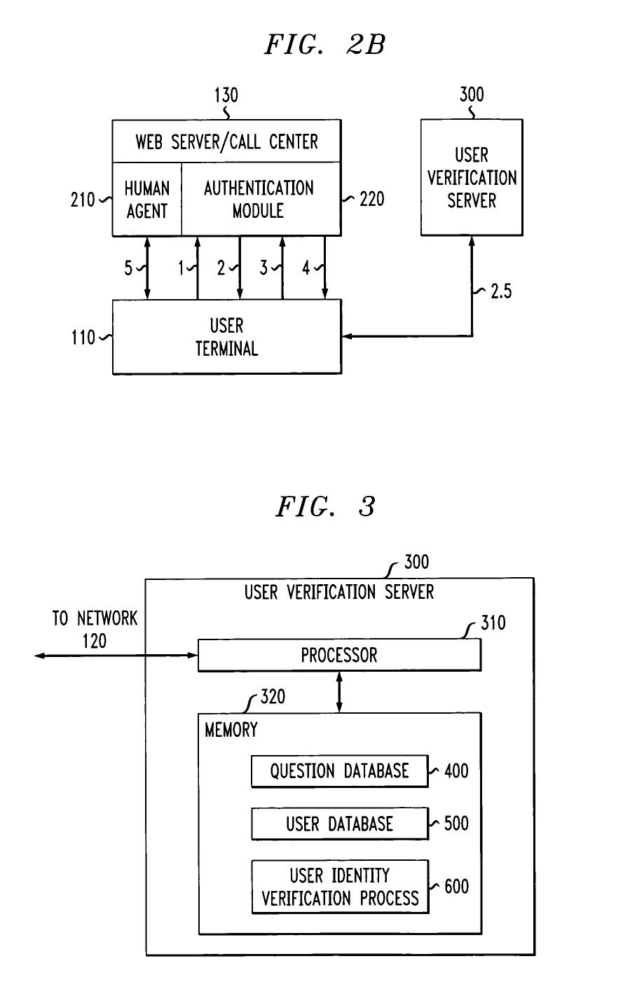

The invention consists of independent enrollment and verification parts, shown in FIGS. 2A and 2B, respectively. As shown in FIG. 2A, a user 110 first contacts the call center 130 (step 1) and if the user 110 has not yet enrolled, then the user 110 is directed to a user verification server 300, discussed further below in conjunction with FIG. 3 (step 2). The user verification server 300 instructs the user 110 to select a number of questions that the user 110 will use for verification. The user 110 selects questions and stores the questions including indices (identifiers) of the questions at the user's location (step 3). This storage can be in a computer file or printed on paper. The user verification server 300 also stores the questions that the user 110 has chosen with corresponding question indices. The user verification server 300 sends the question indices to the call center 130 (step 4). The call center 130 then sends these indices to the user 110 and instructs the user 110 to return corresponding answers or answer indices for each of the question indices back to the call center 130 (step 5). This is the end of enrollment. At this stage, the user verification server 300 has a record of the user 110 along with question indices and textual questions that the user 110 has selected. The call center 130 has a list of question indices along with answers or answer indices to each question that the user has selected. The user 110 has the question indices and textual questions that he or she has selected. The user 110 also has knowledge of the answers for each question.

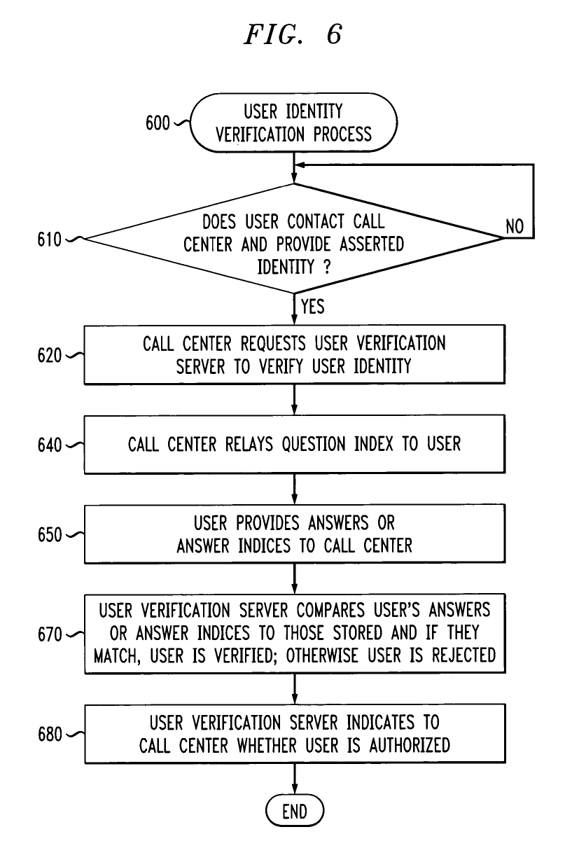

The verification part of the invention is shown in FIG. 2B. The user 110 contacts the call center 130 and is first connected to an authentication module 220 that is part of the call center 130. This module 220 interacts via an interactive voice system (not shown), which does not require a human agent, and asks the user 110 to provide an asserted identity (step 1). The authentication module 220 chooses a random selection of question indices from the list of question indices for that user 110. The authentication module 220 sends this selection of indices to the user 110 (step 2). The user 110 uses the question indices to obtain the text of each question. The user 110 answers each question and returns to the authentication module 220 either the textual answer or an index of that answer (step 3). The authentication module 220 compares received answers or answer indices for each question index against stored answers and if the number of correctly matching answers exceeds a threshold, then the user 110 is verified (step 4); otherwise the user 110 fails verification, in a manner discussed further below in conjunction with FIG. 6. After verification, the user 110 is transferred from the authentication module 220 of the call center to a human agent 210 (step 5).

In a variation of the verification part of the invention, if a user does not have the list of questions corresponding to question indices for the call center 130 because he or she has lost them or for another reason, then the user 110 can obtain these questions again from the user verification server 300 (step 2.5). The user does so by asserting an identity to the user verification server, providing a PIN or password, and stating the call center for which list of questions she needs. Thereupon, the user verification server resends to the user the list of questions and question indices.

FIG. 3 is a schematic block diagram of an exemplary user verification server 300 incorporating features of the present invention. The user verification server 300 may be any computing device, such as a personal computer, work station or server. As shown in FIG. 3, the exemplary user verification server 300 includes a processor 310 and a memory 320, in addition to other conventional elements (not shown). The processor 310 operates in conjunction with the memory 320 to execute one or more software programs. Such programs may be stored in memory 320 or another storage device accessible to the user verification server 300 and executed by the processor 310 in a conventional manner.

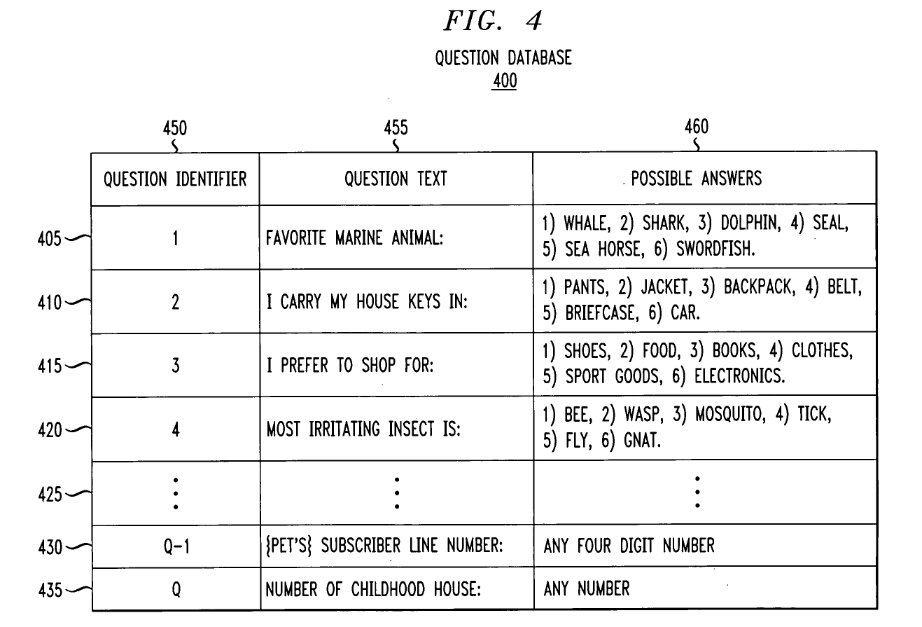

For example, as discussed below in conjunction with FIGS. 4 through 6, the memory 320 may store a question database 400, a user database 500 and a user identity verification process 600. Generally, the question database 400 records a pool of questions for the user to answer. The user database 500 records questions for each user, and the corresponding correct answer. The user identity verification process 600 is a process by which the user verification server 300 verifies the identity of the user 110 on behalf of the call center 130 to protect the privacy of the user's records and the integrity of the information of the call center 130.

FIG. 4 is a sample table from an exemplary question database of FIG. 3. As previously indicated, the question database 400 contains a pool of questions for the user to answer. As shown in FIG. 4, the question database 400 consists of a plurality of records, such as records 405-435, each associated with a different question. For each question, the question database 400 records a question identifier, question text and permitted answers, in fields 450, 455 and 460, respectively. For example, question number 1, in record 405, queries the user for a favorite marine animal (an opinion) and presents the user with six possible multiple choice answers. Similarly, question number (Q-1) queries the user for a portion of a telephone number associated with a particular pet (which may be identified by the user, for example, during the enrollment phase) and accepts any four digit numerical value as an answer.

It is noted that the questions employed by the user verification server 300 may be opinion questions, trivial facts, or indirect facts as described in our U.S. patent application Ser. No. ______ entitled “Method and Apparatus for Authenticating a User Using Query Directed Passwords” (Attorney Docket Number 502078), filed simultaneously herewith and incorporated by reference herein. Alternatively, the questions can be conventional query directed passwords, such as the user's social security number, date of birth or mother's maiden name. The pool of questions should be large enough that if a question is compromised, it can be easily withdrawn and new questions added.

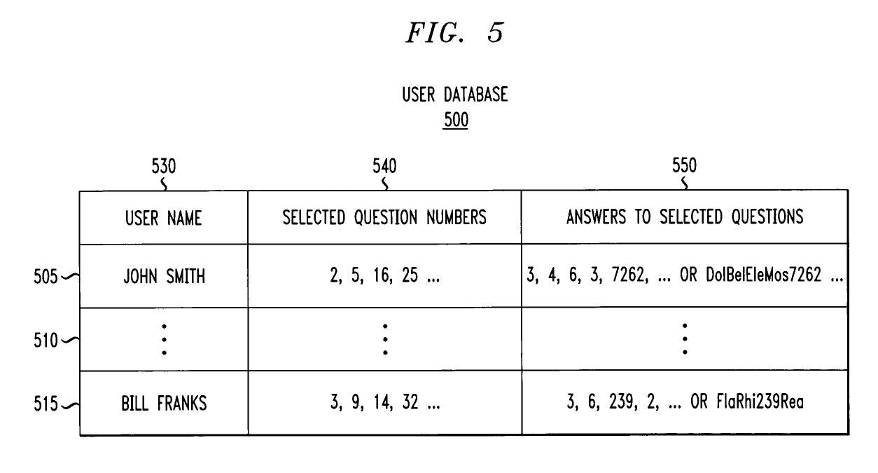

FIG. 5 is a sample table from an exemplary user database of FIG. 3. The user database 500 records questions for each user, and the corresponding correct answer. As shown in FIG. 5, the user database 500 consists of a plurality of records, such as records 505-515, each associated with a different enrolled user. For each enrolled user, the user database 500 identifies the user in field 530, and the selected question numbers in field 540 with the corresponding answers in field 550.

FIG. 6 is a flow chart describing an exemplary implementation of a user identity verification process 600 incorporating features of the present invention. As previously indicated, the user identity verification process 600 is a cooperative process between the user 110, call center 130 and user verification server 300 to identify the user 110 on behalf of the call center 130 to protect the privacy of the user's records and the integrity of the information of the call center 130.

As shown in FIG. 6, the user identity verification process 600 is initiated during step 610 when the user 110 initially contacts the call center 130 and provides an asserted identity. The call center 130 randomly chooses questions from those stored for the user 110 and relays the question indices (or indices) to the user 110 during step 640. The user 110 provides the answers or indices to the answers to the call center 130 during step 650. The call center compares the received answers or answer indices against those stored. If these match, then the call center 130 relays a message to the user 110 that he or she has been verified. If these do not match, then the user 110 is not verified and can be given another chance to verify with the same process, or can be directed to a human agent 210 for verification, or can be rejected and the call terminated.

The question index provided to the user 10 during step 640 may be a written list of questions that the user is given, for example, in a codebook, after registering and choosing questions with the user verification server 300. Each question has a number, which is an index to the questions. The question numbers, however, need not be sequential and can be changed regularly and randomly for security sake. Since the numbers are written down, changing the numbers does not inconvenience the user. A codebook contains the questions selected by a given user and the corresponding possible multiple choice answers. The codebook may be embodied in paper or electronic form. The user has the “key” to the codebook, which is knowledge of the answers to the selected questions. In other words, the codebook itself is a form of “what you have” and the answers are a form of “what you know” authentication. Thus, if the codebook is lost, the answers are not evident (in a similar manner to losing a secure token, without losing the PIN). If the codebook is lost, the user will eventually recognize that the codebook is lost and cancel the current password. Following an enrollment process, a given user, James Smith, can be presented with a wallet card containing the user's questions and multiple choice answers. Thereafter, during a verification process, the user is challenged with only the question indices (numbers) of the subset, M, of questions. The user uses the question indices as an index into the wallet card to identify the questions that should be answered for the corresponding question text. The user may respond with either the answer or the index to the answer. In the preferred embodiment, the user determines the appropriate answers to the requested questions and returns only the multiple choice index of the correct answers. Thus, if someone overhears the question numbers included in the challenge or the multiple choice answers included in the response, they will not obtain the text of the question or the text of the answer, respectively.

Thus, the present invention protects the user identity information in multiple ways. First, even over insecure lines, as most telephone calls are today, the personal information can remain private. In addition, only the user will know the text of both the selected questions and correct answers. This protects against a common problem where an insider steals information to impersonate a user. The agents of the call center 130 will only know the indices to the questions and answers but not know the text to the questions, so there is no awkwardness of the user in sharing this information. These indices may change between different call centers, so two call centers cannot collude to apply stolen verification answers of one to another. The User Verification Center only knows the selected questions and question indices for a user as applied to a particular call center, but does not know the user's chosen answers.

In the preferred embodiment, the authentication between the user and the call center is automated via an interactive voice response (IVR) system. The questions are listed by the call center via speech synthesis and the answer indices are returned by the user via keypad entries on the telephone. Elimination of a human operator in the authentication process saves money for performing authentication to the call center. In addition, if the user forgets the questions, interaction between user and User Verification Center is also done automatically (without human assistance). The question indices and questions are read via speech synthesis by User Verification Center to user.

Although this invention is illustrated via the primary applications of call centers and web contact centers, it should be understood that the present invention pertains to any three-party protocol where person A must prove his or her identity to an authenticating entity B, and there is a third-party authentication service entity C that provides added security to the protocol. This is a more general description of the protocol, where person A corresponds to the user 10 in FIGS. 2A and 2B, entity B corresponds to the call center 130, and entity C corresponds to the verification center 300. As per the protocol, person A knows all information, the questions and answers and their indices. Authenticating entity B knows the indices of the questions and answers. Third-party authentication service entity C knows the questions and answers but only the question indices chosen by person A. In this more general description, entity B could be a call center, web contact center, a company that needed to verify a user identity, a government agency needing to verify a citizen identity, or even a person who needed to verify another person's identity. Entity C could be a user verification web site, a company or government database, a separate database owned by entity B, or a computer file or piece of paper that person A and entity B could both access.

Note that all interactions in this invention where “call center” is used could equally be well be done not by telephone but by Web interaction.

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

1. A method for authenticating a user, comprising:
obtaining an asserted identity of said user;
obtaining a random subset of questions that said user has previously answered with a customer verification server; and
presenting one or more questions to said user from said random subset of questions until a predefined security threshold is satisfied.

2. The method of claim 1, wherein said user is directed to said customer verification server during an enrollment phase.

3. The method of claim 1, wherein said user verification server instructs said user to select and answer a number of questions that will be used for verification.

4. The method of claim 3, further comprising the step of storing said selected questions at said user's location.

5. The method of claim 3, further comprising the step of storing said selected questions at said customer verification server.

6. The method of claim 3, wherein said obtaining step further comprises the step of receiving an indication of said selected questions from said customer verification server.

7. The method of claim 6, wherein said obtaining step further comprises the step of obtaining answers from said user for said selected questions.

8. The method of claim 1, wherein said presenting step is performed by an authentication module.

9. The method of claim 8, wherein said authentication module obtains answers to said presented questions from said user.

10. The method of claim 1, wherein said predefined security threshold is based on a sum of security weights of correctly answered questions.

11. The method of claim 1, wherein one or more of said questions are directed to an opinion of said user.

12. The method of claim 1, wherein one or more of said questions are directed to a trivial fact.

13. The method of claim 1, wherein one or more of said questions are directed to an indirect fact.

14. The method of claim 1, further comprising the step of presenting said user with a larger pool of potential questions for selection of one or more questions to answer.

15. The method of claim 14, further comprising the step of ensuring that said questions selected by said user meet predefined criteria for topic distribution.

16. The method of claim 1, further comprising the step of ensuring that answers to user selected questions cannot be qualitatively correlated with said user.

17. The method of claim 1, further comprising the step of ensuring that answers to user selected questions cannot be quantitatively correlated with said user.

18. The method of claim 1, wherein said questions from said random subset of questions are presented to said user in a random order.

19. The method of claim 1, wherein said questions are presented to said user in the form of an index identifying each question.

20. The method of claim 1, wherein said user responds to said questions by returning an index identifying each answer.

21. The method of claim 20, wherein said index identifying each answer can be aggregated to form a password.

22. The method of claim 20, wherein a portion of each answer can be aggregated to form a password.

23. The method of claim 1, further comprising the step of storing an indication of said subset of questions on a device or wallet card or piece of paper associated with said user.

24. An apparatus for authenticating a user, comprising:
a memory; and
at least one processor, coupled to the memory, operative to:
obtain an asserted identity of said user;
obtain a random subset of questions that said user has previously answered with a customer verification server; and
present one or more questions to said user from said random subset of questions until a predefined security threshold is satisfied.

25. The apparatus of claim 24, wherein said user is directed to said customer verification server during an enrollment phase.

26. The apparatus of claim 24, wherein said customer verification server instructs said user to select and answer a number of questions that will be used for verification.

27. The apparatus of claim 26, wherein said processor is further configured to store said selected questions at said user's location.

28. The apparatus of claim 26, wherein said processor is further configured to store said selected questions at said customer verification server.

29. The apparatus of claim 26, wherein said obtaining step further comprises the step of receiving an indication of said selected questions from said customer verification server.

30. The apparatus of claim 24, wherein said presenting step is performed by an authentication module.

31. The apparatus of claim 24, wherein said processor is further configured to ensure that questions selected by said user meet predefined criteria for topic distribution.

32. The apparatus of claim 24, wherein said processor is further configured to ensure that answers to user selected questions cannot be qualitatively correlated with said user.

33. The apparatus of claim 24, wherein said processor is further configured to ensure that answers to user selected questions cannot be quantitatively correlated with said user.

34. The apparatus of claim 24, wherein said questions from said random subset of questions are presented to said user in a random order.

35. The apparatus of claim 24, wherein said questions are presented to said user in the form of an index identifying each question.

36. The apparatus of claim 24, wherein answers to said questions are received from said user in the form of an index identifying each answer.

37. The apparatus of claim 36, wherein said index identifying each answer can be aggregated to form a password.

38. The apparatus of claim 36, wherein a portion of each answer can be aggregated to form a password.

39. An article of manufacture for authenticating a user, comprising a machine readable medium containing one or more programs which when executed implement the steps of:
obtaining an asserted identity of said user;
obtaining a random subset of questions that said user has previously answered with a customer verification server; and
presenting one or more questions to said user from said random subset of questions until a predefined security threshold is satisfied.
